(19) United States
(12) Patent Application Publication
(10) Pub. No.: US 2012/0136969 A1
(43) Pub. Date: May 31, 2012

(54) MULTI-CAST DOWNLOAD METHOD FOR IMAGE FILE

(75) Inventors: Lian-Cheng Li, Tianjin (CN); Chih-Feng Chen, Taipei (TW)

(73) Assignee: INVENTEC CORPORATION, Taipei (TW)

(21) Appl. No.: 13/069,979

(22) Filed: Mar. 23, 2011

(30) Foreign Application Priority Data
Nov. 30, 2010 (CN) 201010590935.1

(51) Int. Cl. G06F 15/16

(52) U.S. Cl. 709/219

(57) ABSTRACT

A multi-cast download method for downloading an image file is applicable to downloading the image file from an image file server to a computer. The multi-cast download method includes the steps of establishing a wire network connection and a wireless network connection in the computer, in which the wire network connection connects the computer and the image file server; and simultaneously performing a retransmitted packet receiving process and the following steps. The image file is downloaded from the image file server to the computer in a multicast manner by using the wire network connection. When a lost packet is detected, a packet retransmitting request corresponding to the lost packet is sent by using the wireless network connection and Transmission Control Protocol (TIC).

### CROSS-REFERENCE TO RELATED APPLICATIONS

This non-provisional application claims priority under 35 U.S.C. §119(a) on Patent Application No(s). 201010590935.1 filed in China, P.R.C. on Nov. 30, 2010, the entire contents of which are hereby incorporated by reference.

### FIELD OF THE INVENTION

The present invention relates to a multi-cast download method for an image file, and more particularly to a multi-cast download method for an image file capable of improving a multi-cast performance.

### BACKGROUND OF THE INVENTION

No matter being a notebook computer, a large-scale server, or a smart phone, a computer before being provided to a user needs to be installed with an operating system (OS) for the use of the user, or it is necessary to provide a navigation disk or a maintenance disk having the OS for the user. Therefore, the computer manufactures need to install the OS to computers in bulk before shipment. When the OS is installed, each computer needs a corresponding image file.

At present, a common method used in the industry is to carry out fully automatic installation on a large quantity of machines at the same time through a network by using backup and restore tools. It is necessary for each computer to download the required image file from a server and to install the downloaded image file. However, in the conventional download method, once a lost packet is found, the packet needs to be retransmitted to all the computers in a multi-cast manner. Such processing method not only occupies a bandwidth, which makes a download efficiency poor, but also wastes time and the bandwidth for processing a packet for retransmitting for computers that have already received the packet.

### SUMMARY OF THE INVENTION

Accordingly, the present invention provides a multi-cast download method for an image file, which is applicable to downloading at least one image file from an image file server to a computer. The multi-cast download method for the image file comprises: respectively establishing a wire network connection and a wireless network connection in the computer, in which the wire network connection connects the computer and the image file server, and simultaneously performing a retransmitted packet receiving process and the following steps. The image file is downloaded from the image file server to the computer in a multicast manner by using the wire network connection. When a lost packet is detected, a packet retransmitting request corresponding to the lost packet is sent by using the wireless network connection and Transmission Control Protocol (TCP).

The retransmitted packet receiving process may comprise: when the retransmitted lost packet is received by using the wireless network connection and the TCP, the received retransmitted lost packet t is written into a packet retransmitting buffer. Before the step of downloading the image file form the image file server to the computer in the multi-cast manner by using the wire network connection, the multi-cast download method for the image file may further comprise: when the packet retransmitting buffer is not empty, storing the lost packet in the packet retransmitting buffer.

The wire network connection may comprise a wire network interface (NIC) card address (wire NIC address) and a wire connection port of the computer, and the wireless network connection may comprise a wireless network interface card address (wireless NIC address) and a wireless connection port of the computer.

According to an embodiment, the wireless network connection may connect the computer and a packet retransmitting server, and the packet retransmitting server comprises the image file to be downloaded.

According to another embodiment, the wire network connection may connect the computer and a sending module of the image file server; and the wireless network connection connect the computer to a retransmitting module of the image file sever.

According to further another embodiment, the wire network connection and the wireless network connection may both connect the computer and the sending module of the image file server.

In addition, the computer may further download at least one language packet and at least one patch from the image file server to the computer through the wire network connection, and the packet retransmitting server comprises the language packet or the patch for packet supplement.

The wire network connection may connect the computer and the image file server by using an optical fiber, a coaxial cable, a twisted pair wire, or a power line. The wireless network connection may connect the computer and the image file server by using Bluetooth, Wi-Fi, or WiMAX.

In conclusion, according to the multi-cast download method for the image file, after the lost packet is detected, the lost packet is required to be retransmitted through the wireless network connection, and the retransmitted packet is obtained. Therefore, the multi-cast download method for the image file may reduce the load when downloading the image file, and improve the performance of multi-cast download.

### BRIEF DESCRIPTION OF THE DRAWINGS

FIG. 1A is a schematic view of a computer according to an embodiment;

FIG. 1B is a schematic view of a computer according to another embodiment;

FIG. 1C is a schematic view of a computer according to still another embodiment;

FIG. 2A is a flow chart of a multi-cast download method for an image file according to an embodiment; and

FIG. 2B is a flow chart of a retransmitted packet receiving process according to an embodiment.

### DETAILED DESCRIPTION OF THE INVENTION

The detailed features and advantages of the present invention are described below in great detail through the following embodiments, and the content of the detailed description is sufficient for those skilled in the art to understand the technical content of the present invention and to implement the present invention accordingly. Based upon the content of the specification, the claims, and the drawings, those skilled in the art can easily understand the relevant objectives and advantages of the present invention.

A multi-cast download method for an image file is provided, applicable to downloading at least one image file from an image file server to at least one computer. The downloaded image file may be used for installing resources such as an operating system (OS) or various application programs in the computer. The multi-cast download method for the image file may be actually implemented as a daemon running in each computer.

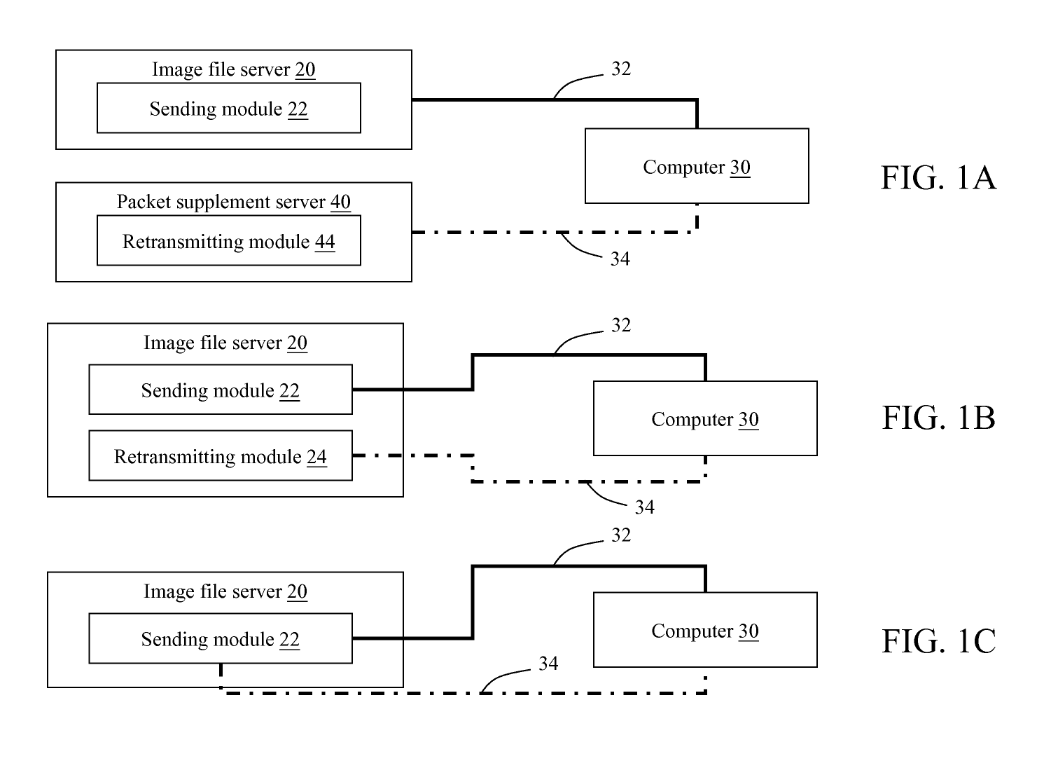

FIG. 1A is a schematic view of a computer according to an embodiment.

In the embodiment of FIG. 1A, the image file server 20 has a sending module 22 for sending the image file to the computer 30 in a multi-cast manner. It should be noted that, although only one computer 30 is taken as an example in the specification, actually, by the multi-cast download method for the image file, the plurality of computers 30 may download the image files at the same time in the multi-cast manner.

The computer 30 may comprise hardware such as a central processor unit (CPU), a memory, and a storage device. The computer 30 may be various computer systems such as a desktop computer, a notebook computer, a server, a personal digital assistant (PDA), and a smart phone, which is not limited herein. The storage device may be, for example, various large-capacity hard disks, a redundant array of inexpensive disk (RAID) system, or a built-in hard disk of a portable device.

The image file refers to a file type such as International Organisation for Standardisation (ISO) 9660 file system, or Microsoft Windows Imaging (WIM). The content of the image file may be a kernel program of the OS, for example, a kernel program corresponding to a Windows XP system or a Windows 7 system. The image file server 20 may comprise the image files corresponding to various installation requirements, so as to satisfy possible needs of the computers 30.

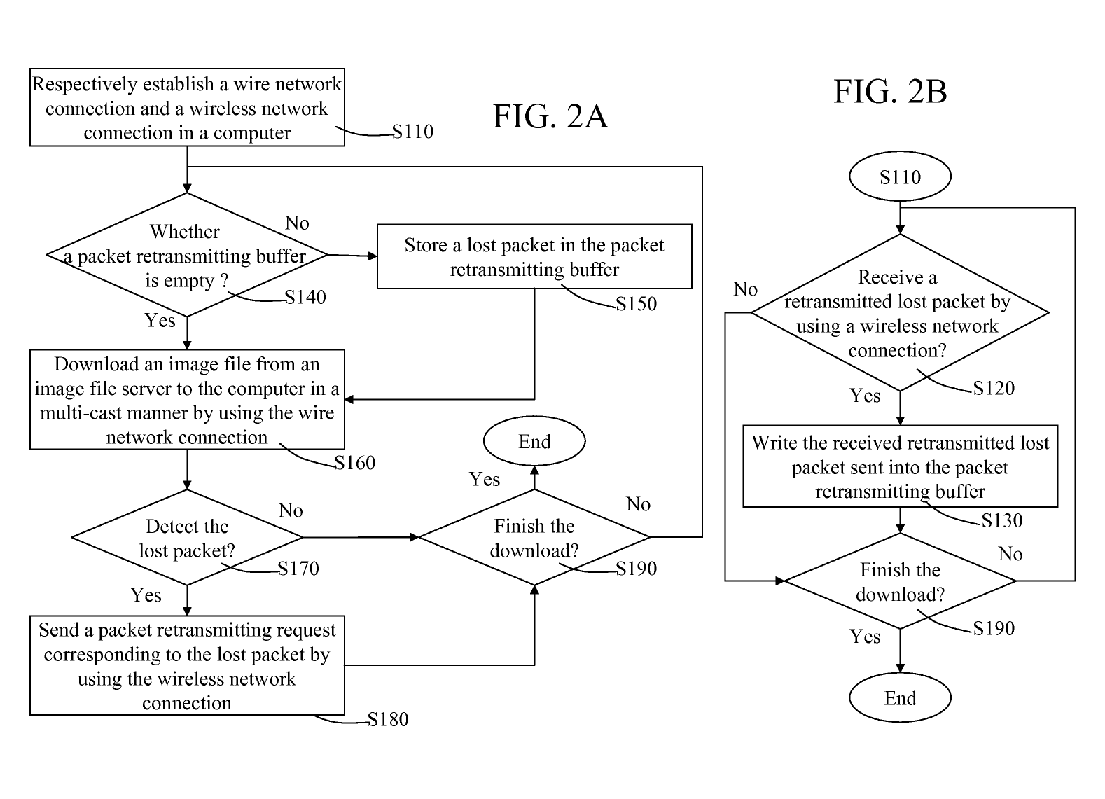

Referring to FIG. 2A and FIG. 2B in combination with FIG. 1A, FIG. 2A and FIG. 2B are respectively a flow chart of a multi-cast download method for an image file according to an embodiment and a flow chart of a retransmitted packet receiving process. Before downloading, firstly, a wire network connection 32 and a wireless network connection 34 are respectively established in the computer 30 (Step S110), in which the wire network connection connects the computer 30 and the image file server 20. More specifically, in the embodiment of FIG. 1A, the wire network connection 32 connects the computer 30 and the sending module 22 of the image file server 20.

The wire network connection 32 may connect the computer 30 and the image file server 20 by using an optical fiber, a coaxial cable, a twisted pair wire, or a power liner, and may use various network communication protocols such as User Datagram Protocol (UDP) and Internet protocol (IP).

According to the multi-cast download method for the image file, a wireless network range may be constructed by using at least one wireless base station. A packet retransmitting server 40 and all the computers 30 in the wireless network range may use the wireless network connection 34. More specifically, the computer 30 is enabled to use the wireless network function and to establish the wireless network connection 34 with a retransmitting module 44 of the pack retransmitting server 40. The wireless network connection 34 may connect the computer 30 and the packet retransmitting server 40 by using Bluetooth, Wi-Fi (IEEE 802.11a/b/g/n), or WiMAX (IEEE 802.11a/b/g/n).

More specifically, the wire network connection 32 may comprise a wire network interface (NIC) address and a wire connection port of the computer 30. The wireless network connection 34 may comprise a wireless NIC address and a wireless connection port of the computer 30. In other words, the computer 30 may have a wire NIC and a wireless NIC at the same time, and set different connection ports for the wire network connection 32 and the wireless network connection 34 for using.

Then, the computer 30 simultaneously performs a retransmitted packet receiving process and the following steps from Step S160 to Step S190. The computer 30 downloads the image file from the image file server 20 to the computer 30 in the multi-cast manner by using the wire network connection 32 (Step S160). In addition, the computer 30 may further download at least one language packet and at least one patch to the computer from the image file server 20 to the computer 30 through the wire network connection 32. The packet retransmitting server 40 may also comprise the language packet or the patch for retransmitting.

When downloading the image file, the language file, or the patch in the multi-cast manner through the wire network connection 32, the computer 30 continuously determines whether at least one lost packet is detected (Step S170). For example, when the received network packet cannot form complete data, the computer 30 may know that transmission of a network packet fails and the network packet is determined as the lost packet. Technologies for detecting the lost packet is mature in the filed of network transmission, and the details will not be described herein again.

When the lost packet is detected, the computer 30 sends a packet retransmitting request corresponding to the lost packet through the wireless network connection 34 and Transmission Control Protocol (TCP) (Step S180).

In addition, in the retransmitted packet receiving process, the computer 30 may continuously determine whether a retransmitted lost packet is received by using the wireless network connection 34 and TCP (Step S120). When the retransmitted lost packet is received by using the wireless network connection 34 and TCP, the received retransmitted lost packet may be written into a packet retransmitting buffer of the computer 30 (Step S130).

Before Step S170 is performed, it is continuously determined whether the packet retransmitting buffer is empty (Step S140); when the packet retransmitting buffer is not empty, the lost packet in the packet retransmitting buffer is stored (Step S150).

After receiving the full packets, the computer 30 may combine data in the packets and decompress the data, so as to obtain a data block belonging to the image file and store the data block into a disk of the computer 30. If the retransmitted lost packet sent by the packet retransmitting server 40 is found in the packet retransmitting buffer in Step S150, the data block corresponding to the lost packet may be obtained according to the lost packet and other relevant packets, and then the data block is stored into the disk.

Since the data size of the lost packet is not large, and only few computers 30 among all computers 30 may lost the packets, the computer 30 that detects the lost packet requires the retransmitted lost packet through the wireless network connection 34. At the same time, the computer 30 that detects the lost packet may continue downloading the image file through the wire network connection 32. In addition, in order to ensure that the retransmitted lost packet will be actually delivered to the computer 30, the retransmitting module 44 may employ TCP for packet supplement. The computer 30 may determine whether the downloading of the image file is finished at any time (Step S190). If the downloading of the image file or other required files is finished, the wire network connection 32 and the wireless network connection 34 can be closed, and the downloading process is ended. Otherwise, the retransmitted packet receiving process is continuously performed, the downloading is performed through the wire network connection 32 and the detection of whether the packet is lost continues.

In addition, FIG. 1B and FIG. 1C are respectively schematic views of computers according to different embodiments. In the embodiment of FIG. 1B, the image file service 20 at the same time has the function of the packet retransmitting server 40. The image file server 20 may comprise a retransmitting module 24, and the retransmitting module 24 is connected with the computer 30 through the wireless network connection 34 and provides a packet retransmitting service.

Similarly, no additional packet retransmitting server 40 needs to be configured in the embodiment of FIG. 1C. The sending module 22 of the image file server 20 may at the same time have functions of sending network packets in the multi-cast manner by using the wire network connection 32, receiving the packet retransmitting request by using the wireless network connection 34, and sending the retransmitted lost packet through the TCP.

In conclusion, in the multi-cast download method for the image file, the image file is downloaded through the wire network connection; after the lost packet is detected, the lost packet is required for being retransmitted through the wireless network connection; and the retransmitted lost packet is obtained. The lost packet is separately retransmitted to the computer needing the retransmitted lost packet through TCP, and no bandwidth of the wire network connection is occupied. Therefore, on the whole, the multi-cast download method for the image file can download the image file with a small load, and improve the performance of the multi-cast download.

What is claimed is:

1. A multi-cast download method for an image file, applicable to downloading at least one image file from an image file server to a computer, the multi-cast download method for the image file comprising:
respectively establishing a wire network connection and a wireless network connection in the computer, wherein the wire network connection connects the computer and the image file server; and
simultaneously performing a retransmitted packet receiving process and following steps:
downloading the image file from the image file server to the computer in a multi-cast manner by using the wire network connection; and
sending a packet retransmitting request corresponding to at least one lost packet by using the wireless network connection and Transmission Control Protocol (TCP), when the lost packet is detected.

2. The multi-cast download method for the image file according to claim 1, wherein the wire network connection comprises a wire network interface card address and a wire connection port of the computer, and the wireless network connection comprises a wireless network interface card address and a wireless connection port of the computer.

3. The multi-cast download method for the image file according to claim 1, wherein the retransmitted packet receiving process comprises:
writing the received retransmitted lost packet into a packet retransmitting buffer, when the retransmitted lost packet is received by using the wireless network connection and the TCP.

4. The multi-cast download method for the image file according to claim 3, before the step of downloading the image from the image file server to the computer in the multi-cast manner by using the wire network connection, the multi-cast download method for the image file further comprising:
storing the lost packet in the packet retransmitting buffer, when the packet retransmitting buffer is not empty.

5. The multi-cast download method for the image file according to claim 1, wherein the wireless network connection connects the computer and a packet retransmitting server, and the packet retransmitting server comprises the image file.

6. The multi-cast download method for the image file according to claim 5, wherein the computer downloads at least one language packet and at least one patch from the image file server to the computer through the wire network connection, and the packet retransmitting server comprises the language packet and the patch.

7. The multi-cast download method for the image file according to claim 1, wherein the wire network connection connects the computer and a sending module of the image file server, and the wireless network connection connects the computer and a retransmitting module of the image file server.

8. The multi-cast download method for the image file according to claim 1, wherein the wire network connection and the wireless network connection connect the computer and a sending module of the image file server.

9. The multi-cast download method for the image file according to claim 1, wherein the wire network connection connects the computer and the image file server by using an optical fiber, a coaxial cable, a twisted pair wire or a power line.

10. The multi-cast download method for the image file according to claim 1, wherein the wireless network connection connects the computer and the image file server by using Bluetooth, Wi-Fi, or WiMAX.
